(19) United States
(12) Patent Application Publication
(10) Pub. No.: US 2009/0158601 A1
(43) Pub. Date: Jun. 25, 2009

(54) Creative Designing Apparatus

(76) Inventor: Herschel James Davis, Terre Haute, IN (US)

Correspondence Address: Kenneth Bower, 314 Ironstone Lane, Elverson, PA, 19520, US

(21) Appl. No.: 12/338,979

(22) Filed: Dec. 18, 2008

Related U.S. Application Data
(60) Provisional application No. 61/006,096, filed on Dec. 19, 2007.

(51) Int. Cl. B43L 13/20

(52) U.S. Cl. 33/27.12

(57) ABSTRACT

Disclosed is a tool for decorating an environmentally friendly surface with an irregular pattern. One way of using the tool is to mount the central pivot onto the mounting for a ceiling light fixture. Applying wet plaster or paint to the area around the central pivot and removing some of the wet plaster or paint in a pattern by manually rotating a marking instrument about the pivot while a cam and arm restrict the movement of the marking instrument to a path that reproduces the contour of one of a selection of cams. The resulting pattern achieves the effect of a medallion that is previously achieved by manually molding plaster or adhering a plastic appliqué to the ceiling.

### CROSS-REFERENCE TO RELATED APPLICATIONS

This application claims U.S. Provisional Application No. 61/006,096 filed on Dec. 19, 2007

### SEQUENCE LISTING

Not Applicable

### STATEMENT REGARDING FEDERALLY SPONSORED RESEARCH OR DEVELOPMENT.

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention is a tool that provides new creative capabilities to the field of interior decorating. Building technology is rapidly changing in response to customer demand for environmental conscious living spaces. The current trend in environmentally conscious building is to apply natural clay materials not requiring paint or application of low VOC (Volatile Organic Compound) paints to walls and ceilings to reduce or eliminate harmful out-gassing into the living spaces after construction. The present invention provides an easy to use and cost effective tool to create a design on a ceiling, or walls for use with these environmentally friendly surface treatments. The creative design features making the rich diversity of environmentally friendly decors possible using the instant invention are as follows: A stationary pivot is attachable to a wall or ceiling. Interchangeable cams with irregular contours surround the pivot. A single element connects the cam to the brush. There is radial restriction of movement of the brush by the cam during manual rotation of the brush around the pivot. The brush displaces or removes environmentally friendly material from the surface.

2. Description of Related Art

U.S. Pat. No. 2,734,271 to Moriarty discloses a pantograph with a stationary pivot attached to a table, multiple permanently installed cam segments with regular smooth contours with a center different from the position of the pivot, multiple linkage elements connecting the cam to the pencil or pen. Radial restriction of movement of the pencil or pen by the cam during manual rotation of the pencil or pen around the pivot while the pencil or pen adds material to the medium temporarily attached to the table.

U.S. Pat. No. 3,817,178 to Hagen discloses a paint application pad (additive marking process) that is guided around a ceiling by a number of pivots and a flexible member or chain to make a pattern determined by the geometry of the room rather than around a central pivot as in Moriarty.

U.S. Pat. No. 4,258,898 to Tuzzolino discloses an apparatus for finishing wet plaster using one or more brushes that are moved about the surface without the aid of a cam or guide or patterns applied directly to the plaster by implements configured like cookie cutters.

U.S. Pat. No. 6,680,083 to Ray et al. discloses a ceiling design tool that can be described as a rubber disk mounted on the end of a handle supported, rigid disk of slightly smaller size, where the rubber is formed to cover the circular edge of the rigid disk. Wet plaster is applied to the ceiling, and the rubber disk is subsequently brought into contact with the wet surface and withdrawn, moving the disk to multiple locations and repeating the process, making a non-uniform pattern in the surface of the plaster with no particular relationship to any feature in the ceiling nor the guidance of a cam or master.

U.S. Pat. No. 4,571,836 to Poll discloses a stationary pivot attachable to a drafting table, interchangeable cams with regular contours that surround the pivot, multiple element connecting the cam to the pencil or pen, radial restriction of movement of the pencil or pen by the cam during manual rotation of the pencil or pen around the pivot while the pencil or pen displaces or removes material from the removable medium from the drafting table. The linkage appears to be limited to following gradually changing curves and no provision is made for centering the template about any feature on the surface to which it is mounted. None of the above inventions and patents singly or in combination is seen to describe the present invention as claimed.

### BRIEF SUMMARY OF THE INVENTION

The primary objective of the present invention is to provide a creative and functional approach for making medallion patterns around ceiling light fixtures.

A further objective of the present invention is to provide a tool for interior decorating of environmentally sensitive living spaces.

A further objective of the present invention is to make medallion patterns without the addition of materials.

A further objective of the present invention is to reduce the skill level of making wall or ceiling patterns by the use of a single, easy to operate apparatus.

A further objective of the present invention is to aid a user in making identical patterns where multiple patterns are in one living space.

A further objective of the present invention is to aid a user in making unique patterns from a choice of interchangeable cams, marking instruments and marking media.

A further objective of the present invention is to provide a platform for wall and ceiling decorating that can incorporate further enhancements, such as making non-symmetrical cams, adding color or a supply of colorant, power driving the rotation of the writing instrument around the pivot and use of a wide variety of other marking instruments (rollers, sponges, etc.).

The present invention is a tool for decorating the surfaces of a building in an environmentally friendly manner. The pattern is generated by movement of a stiff brush against the surface of the ceiling or walls to remove or displace material. Because the brush is manually rotated around a pivot while being displaced towards and away from the pivot by a cam surface, it is ideally suited to making patterns made up of straight and curved lines in an essentially circular arrangement around some feature on the surface of a wall or ceiling being patterned, such as a light fixture. The deflection of light from the pattern that is so generated will be different from that of the un-patterned surface making the attractive pattern visible.

The preferred embodiment of the present invention provides additional unique features by having a set location for the pivot and cam with respect to a lighting fixture or other feature of a ceiling or wall. The pattern being reproduced on the ceiling is made by removing a paint or wet surface of the building material from the ceiling or wall. The apparatus of the present invention is semi-automated in that the user rotates the marking instrument around the pivot while the cam restricts the motion of the marking instrument to movement towards or away from the pivot. The resulting pattern has a similar but much more flexible design, commonly called a medallion, that has hereto for been achieved by plaster molding or adhering a vacuum formed plastic appliqué to the ceiling.

Additional applications for the present invention include application of either environmentally friendly or conventional paints or achieving a variety of textures and color effects by attachment of alternative marking instruments such as sponges, rollers, crumpled sheet material and devices that replenish the supply of paint during application. Non-symmetrical shapes can also be patterned on a surface by locating the cam off center from the pivot or making the cam itself with a non-symmetrical pattern.

The unique features of the apparatus of the present invention are a stationary pivot attachable to a wall or ceiling, interchangeable cams with irregular contours that surround the pivot, a single element connecting the cam to the brush, radial restriction of movement of the brush by the cam during manual rotation of the brush around the pivot while the brush displaces or removes material from the surface pivot is at the center of the cam which is also the center of the design being reproduced on the building or other surface. The pattern is changed by installing a cam having an alternate contour. The contour of the cam can include sharp, acute, and obtuse angles as well as straight lines that when extended intersect the pivot.

Neither Moriarity, Hagan, Tuzzolino, Ray et al. nor Poll disclose many of the aforementioned unique features, nor do they suggest their combination to become the apparatus of the preferred embodiment or any other application of the apparatus herein claimed or described.

### BRIEF DESCRIPTION OF THE SEVERAL VIEWS OF THE DRAWING(S)

FIG. 1 is a perspective view of the entire apparatus.

FIG. 2 is a side view of the cam follower.

FIG. 3 is a side view of the slide bar.

FIG. 4a is a side view of the junction box mount.

FIG. 4b is a top view of the junction box mount.

FIG. 5a-5d are top views of cams having a variety of contours.

### DETAILED DESCRIPTION OF THE INVENTION

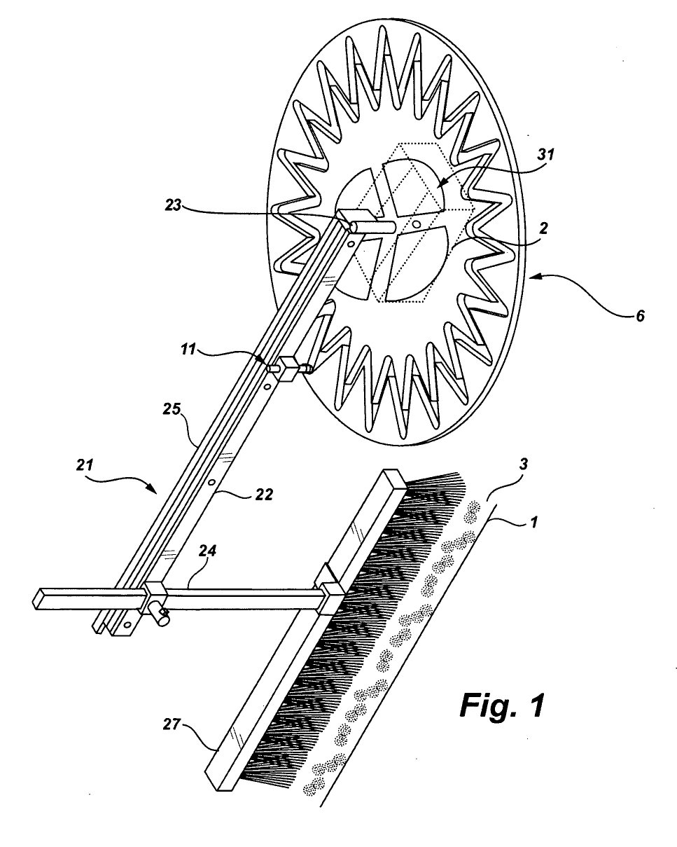

Referring to FIG. 1, a creative designing apparatus 5 is shown. The creative designing apparatus 5 has a junction box mount 31 that attaches to an electrical junction box 2 in an area of a substrate 1, or surface. The creative designing apparatus 5 has a groove plate 6, or cam, that attaches via screw or other quick fastener to the junction box mount 31. A slide bar 21 is pivotally attached to the groove plate 6 by a pivot pin 23, or pivot. The slide bar 21 has a rotary bar 25, or single arm, attached to the pivot pin 23. The pivot pin 23 enables 360 degrees of rotation for the slide bar 21. An applicator 27 is slidably attached to an applicator mount bar 24, or marking instrument holder, which is slidably attached to a rotary bar 25 via slider 22, or link. As the slide bar 21 is manually rotated around pivot pin 23, the applicator mount bar 24 is moved toward and away from the pivot pin 23 by the contact between a cam follower 11 and a cam 7, or cam contour, which is formed in the groove plate 6. Therefore, the applicator 27 forms a pattern using coating fluid 3, or material, on the substrate 1 that roughly matches the pattern of the cam 7. The coating fluid 3 can be plaster, paint or other fluid material which is used to finish the substrate 1.

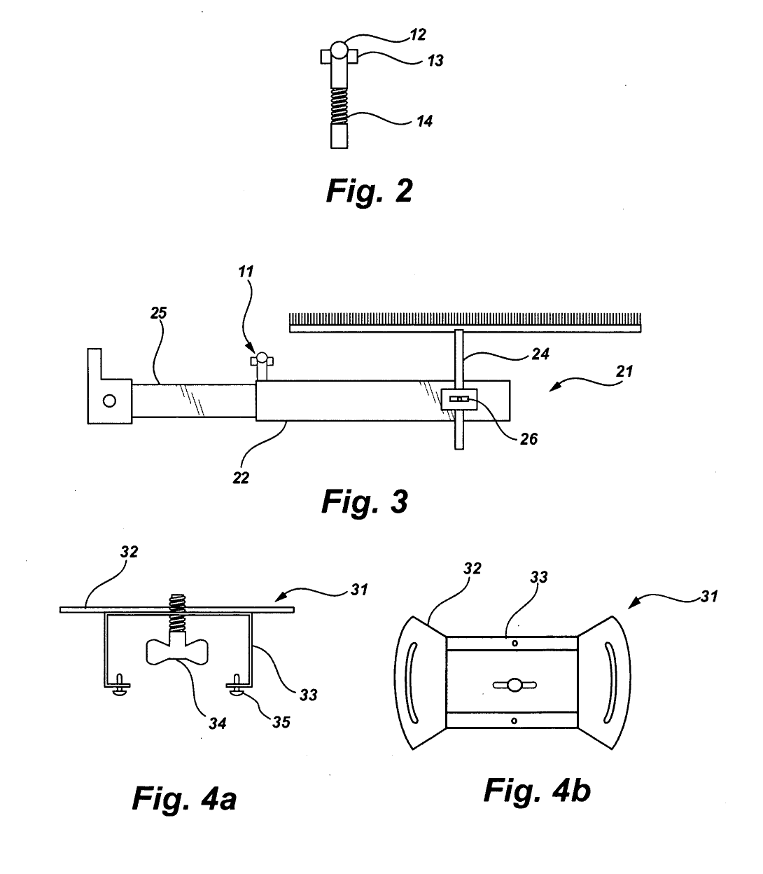

Referring now to FIG. 2, the cam follower 11 is shown in a plan view. The cam follower 11 has a cam engaged nose 12 which contacts the cam on one or more sides. The cam engaged nose 12 can be semi-spherical, as shown, or it can be cylindrical. Attached to the cam engaged nose 12 is a shoulder 13, which is cylindrical. The shoulder 13 is urged against the groove plate 6 by a spring biased pin 14.

Referring now to FIG. 3 the slide bar 21 is shown in a plan view. The slide bar 21 is comprised of the rotary bar 25 with a slidably attached applicator mount bar 24, wherein the slidable attachment is accomplished by means of the slider 22. The applicator mount bar 24 can be moved vertically and locked in position by a thumb screw 26.

Referring now to FIGS. 4a-b, the junction box mount 31 is shown in a side view in FIG. 4a and in a top view in FIG. 4b. The junction box mount 31 has first an adapter plate 32. The adapter plate 32 is detachably mounted to the electrical junction box 2 using threaded fasteners. Next a spacer 33 is attached to the adapter plate 32 by a mount thumb screw 34. Finally, the groove plate 6 (not shown) can be attached to the spacer 33 by groove plate mount screw 35.

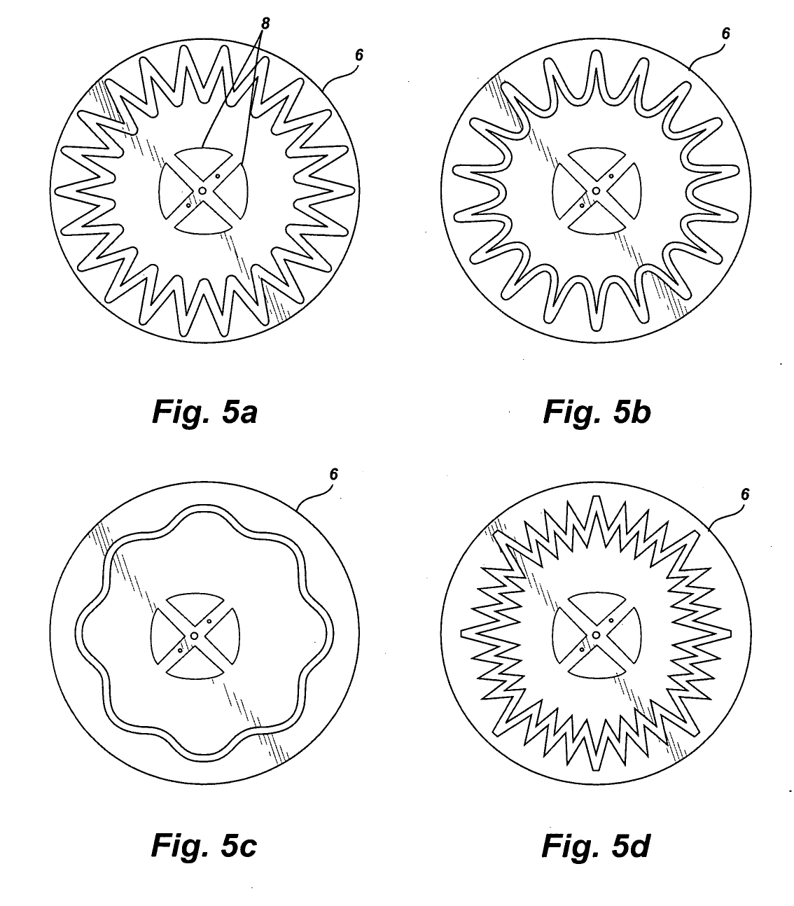

Referring now to FIGS. 5a-d, the groove plate 6 is shown with multiple different cam profiles. As seen the cam can take the shapes of multi-pointed stars, rosettes, flowers, polygons, or other non symmetrical patterns. In addition, each groove plate 6 has one or more screw access opening 8, which enable easier access to the fasteners in the junction box mount 31.

It is to be understood that the invention is not limited in its application to the details of construction and to the arrangements of the components set forth in the preceding description or illustrated in the drawings. The invention is capable of other embodiments and of being practiced and carried out in various ways. By way of example, in another embodiment, the slide bar could be motorized with a standard DC or AC electric motor (not shown in the figures). Also, it is to be understood that the phraseology and terminology employed herein are for the purpose of the description and should not be regarded as limiting.

1. An apparatus for marking a pattern on a surface, comprising:
a pivot that is attached to the surface;
a single arm extending radially from the pivot;
a cam attached to the pivot;
a cam contour;
a cam follower;
a marking instrument holder;
a link connecting the marking instrument holder with the cam follower;
a marking instrument.

2. The apparatus of claim 1, wherein:
the pivot is attached to a feature on the surface.

3. The apparatus of claim 1, wherein:
the surface is a wall or a ceiling.

4. The apparatus of claim 1, wherein:
the feature is the mounting for a light fixture.

5. The apparatus of claim 1, wherein:
the cam totally surrounds the pivot.

6. The apparatus of claim 1, wherein:
the cam is removably attached to the pivot.

7. The apparatus of claim 1, wherein:
the cam contour is made up of straight, angular and curved surfaces.

8. The apparatus of claim 1, wherein:
there are two equally spaced cam contours.

9. The apparatus of claim 1, wherein:
the cam follower comprises a spring biased ball.

10. The apparatus of claim 1, wherein:
the cam contour positively moves the marking instrument holder towards and away from the pivot.

11. The apparatus of claim 1, wherein:
a link connecting the cam follower with the marking instrument holder moves in parallel relation to the single arm.

12. The apparatus of claim 1, wherein:
the marking instrument has a plurality of extensions that contact the surface.

13. The apparatus of claim 1, wherein:
the plurality of extensions displace or remove material from the surface.

14. The apparatus of claim 1, wherein:
the marking instrument is rotated about the pivot and moved radially towards and away from the pivot by the cam contour.

15. The apparatus of claim 1, wherein:
the material being displaced or removed is environmentally friendly.

16. The apparatus of claim 1, wherein:
the material being displaced or removed from the surface is wet plaster.

17. The apparatus of claim 1, wherein:
the material being displaced or removed from the surface is wet clay.

18. The apparatus of claim 1, wherein:
the material being displaced or removed from the surface is low VOC paint.

19. The apparatus of claim 1, wherein:
the marking instrument is applying a material to the surface.

20. The apparatus of claim 1, wherein:
the pivot is attached to a feature on the surface;
the surface is a wall or a ceiling;
the feature is the mounting for a light fixture;
the cam contour totally surrounds the pivot;
the cam is removably attached to the pivot;
the cam contour is made up of straight, angular and curved surfaces;
there are two equally spaced cam contours;
the cam follower comprises a spring biased ball;
the cam contour positively moves the cam follower towards and away from the pivot;
a link connecting the cam follower to the marking instrument holder moves in parallel relation to the single arm;
the marking instrument has a plurality of extensions that contact the surface;
the extensions displace or remove material from the surface;
the marking instrument is rotated about the pivot and moved radially towards and away from the pivot by the cam contour;
the material being displaced or removed is environmentally friendly.
